(19) United States
(12) Patent Application Publication
(10) Pub. No.: US 2024/0130546 A1
(43) Pub. Date: Apr. 25, 2024

(54) PILLOW WITH THERMAL ELEMENT

(71) Applicant: BROOKJ VENTURES LLC, Miami, FL (US)

(72) Inventor: Brook T. Johnston, Miami, FL (US)

(73) Assignee: BROOKJ VENTURES LLC, MIAMI, FL (US)

(21) Appl. No.: 17/972,070

(22) Filed: Oct. 23, 2022

(51) Int. Cl. A47G 9/10; A63H 3/00; A63H 3/02; H02J 7/00; H05B 1/02

(52) U.S. Cl. CPC A47G 9/1036; A47G 9/1045; A63H 3/003; A63H 3/02; H02J 7/0042; H05B 1/0272; A47G 2009/006

(57) ABSTRACT

A character pillow incorporating a thermal element having a removable and rechargeable energy disposed within a pocket member, the pillow adapted to be immersible in water.

### FIELD

The presently disclosed subject matter is directed to pillows and more specifically to a character pillow incorporating a heating element.

### BACKGROUND

There are a great number of people who suffer from pain that is derived from a number of sources. Regardless of its origin, essential in relieving this pain is the application of heat directly to the area. Conventional treatment often dictates the use of a hot water bottle or heating pad. While such a treatment regimen has worked well for generations, the sterile and medical appearance of a water bottle or heating pad is often intimidating to young children. They tend to quickly put the heating appliance down and do not gain the benefit of the device. Further, use of a water bottle often results in water spillage or dampness and a heating pad can be restrictive in terms of requiring it to be plugged in. Additionally, having a character pillow with overall aesthetic appeal as well as a pillow that is washable greatly helps continued usage by the child with the added benefit of managing cleanliness. Accordingly, there exists a need for a pillow incorporating a heating element for the reduction of pain, anxiety or for comfort.

### SUMMARY

The principles of the present embodiments provide for a character pillow that has a main body having a plurality of external features that may include a representation of common designs recognizable by children such as a rainbow, or character figure features such as an eye area, a pair of paw areas, a pair of arms, a pair of legs, a face, a pair of ears, or a tail. The above are provided by means of explanation and not intended to be limiting.

The pillow member has an outer shell of preferably plush material that is made up of an upper material layer and a lower material layer that are secured to one another to form a shell. The shell has an opening that will accommodate resilient fill material to be placed in the interior of the shell. One form of pillow is shown in FIGS. 1-9 wherein the character pillow is in the form of a bear character. The character includes an opening with a pocket member that is adapted to accommodate a removable battery pack and terminal wire ends. Secured to the battery pack are the terminal wire ends that are electrically secured to a combination of thermal elements that are designed to transmit heat to the surrounding area. The thermal elements are dispersed throughout the interior of the character pillow. The battery pack has a charging port connecting to a charging cable, a distal end of the charging cable connects either to an USB charging adapter which is adapted to connect to an AC power plug to charge the stuffed animal or directly to the AC power plug. The battery pack is preferably disposed within a main portion of the character pillow and the character pillow may have a removable cover that is secured with a fastening member. In the present form where the cover is not removable, the fastening member joins two ends of the opening together on the outer surface of the body.

The center torso area may also contain a speaker that is electrically connected to a wireless transmitter that is adapted to be paired to a personal electronic device to play audible entertainment material through the speaker. The thermal element may also be adapted to pair with a personal electronic device to control activation and heat settings remotely.

The body may be a teddy bear body or take any form of character. The eye area may be a pair of LEDs for improving an aesthetic visual quality of the body. A power switch may conduct power to the series of thermal elements and the pair of LEDs. One of the pair of paw areas may include the power switch. The power switch may be electrically connected by a plurality of internal wires to the battery pack. Electrical power may be derived from the USB charging adapter of an A/C plug as well as rechargeable batteries and is routed along the charging cable to the charging port. The opening provides access to a plurality of internal electrical components for maintenance, repair, removal, or washing the body. The fastening means may be a fastener selected from the group consisting of a zipper, a hook-and-loop-type fastener, or one or more snaps. An interior of the center torso area may contain a rechargeable battery. The rechargeable battery may be charged via a charging regulator that may be connected to the charging port. The charging port may be electrically connected to the charging regulator which controls a plurality of charging current to the rechargeable battery to allow for the rechargeable battery to be charged even if the stuffed animal is off and not being used. The cavity may be bordered and contained by the cloth divider and the shell. The cavity may contain the rechargeable battery, the charging regulator, all of the internal wiring, and the speaker.

A cavity under the shell at the center torso area may have an internal cloth divider that retains the stuffing material about the center torso area or main portion of the pillow. The wireless transmitter may be adapted to be paired to the personal electronic device for playback of audio material through the speaker or control of the thermal elements and is wired in parallel. The series of thermal elements may be energized by the rechargeable battery to produce an amount of heat for pain relief and overall comfort when adapted to be held close to a user's body. The series of resistance heaters may be electrically connected by a plurality of internal wiring. A motor may activate a vibrating device that transmits a slight vibratory effect to the stuffed animal to aid in adapted to be soothing a user. The series of resistance heaters, the pair of LEDs, and the motor may be wired in parallel.

### BRIEF DESCRIPTION OF THE DRAWINGS

FIG. 1 is a front view of a combined pillow with a thermal element;

FIG. 2 is a front, cut away view of FIG. 1 demonstrating the internal elements;

FIG. 3 is a back, cut away view of FIG. 1 demonstrating the internal elements;

FIG. 4 is an exploded view of the internal elements of FIG. 1;

FIG. 4A is a detail view of the thermal pads as shown in FIG. 4;

FIG. 5 is a rear view of FIG. 1;

FIG. 6 is a cross-section view about lines 6-6 as shown in FIG. 3;

FIG. 7 is a cross-section view about lines 7-7 of FIG. 1;

FIG. 8 is a sectional view about lines 8-8 of FIG. 1 showing an alternate form; and

FIG. 9 is an electrical block diagram of the thermal element of FIG. 1.

### DETAILED DESCRIPTION

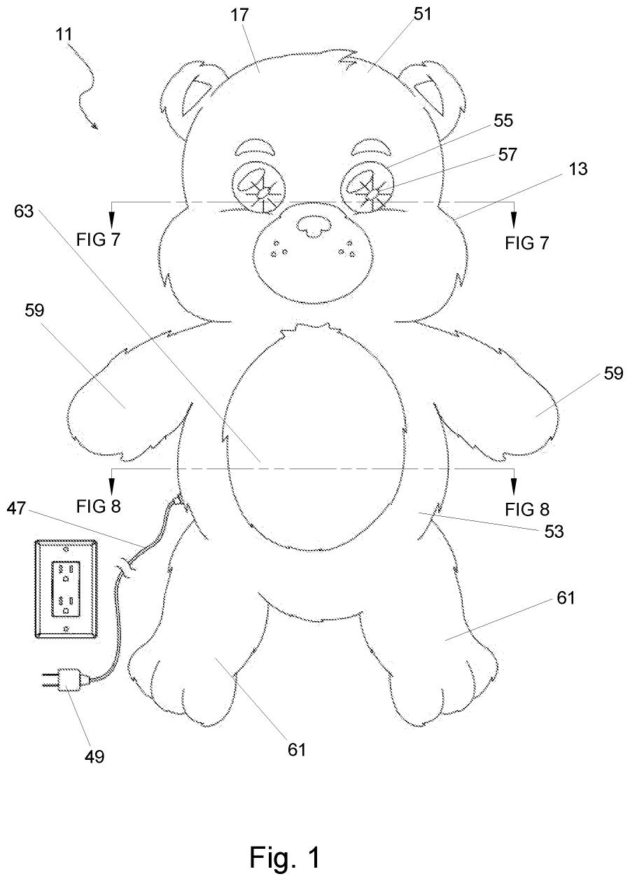

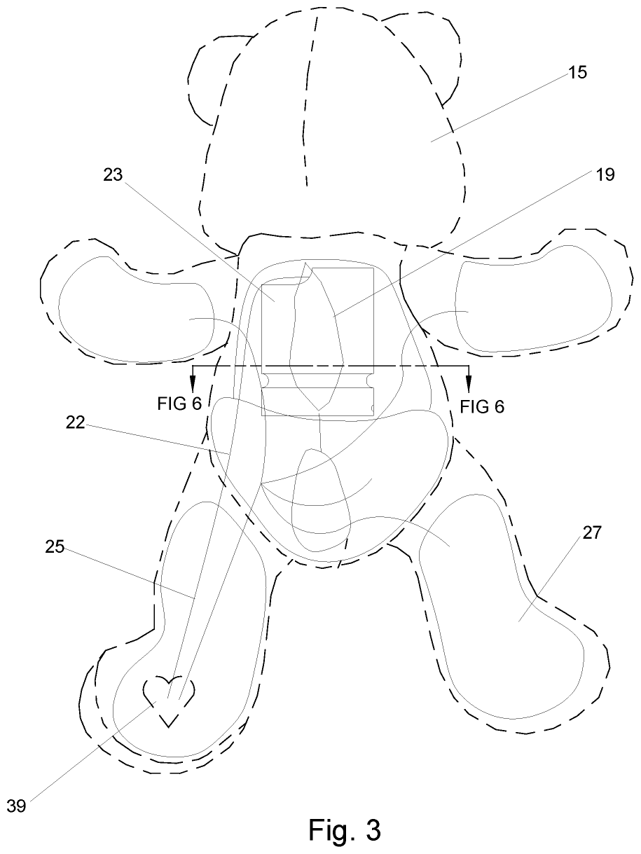

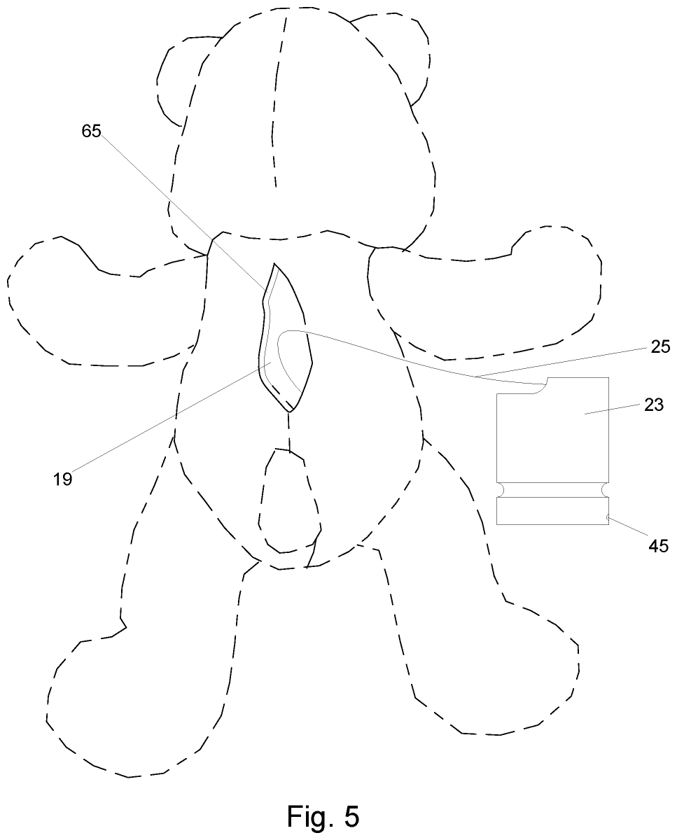

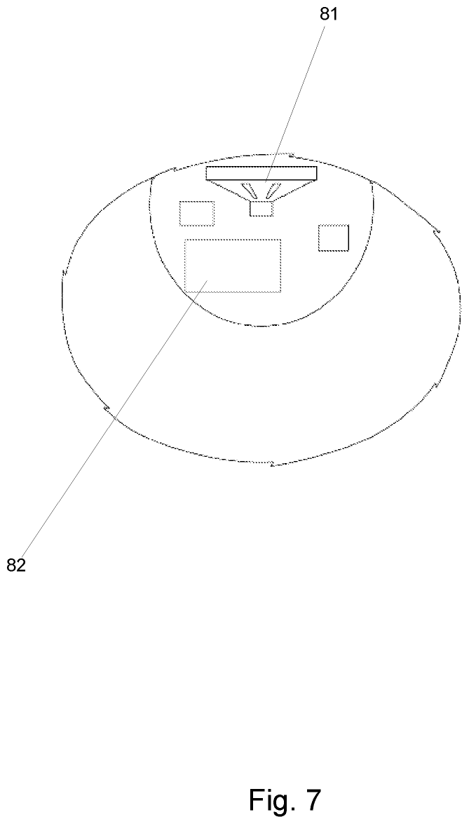

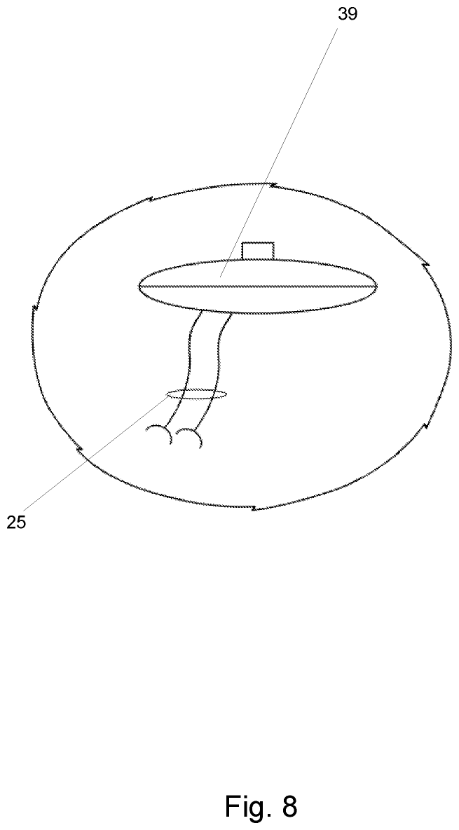

The best mode for carrying out the embodiments as described, herein depicted in FIGS. 1 through 9. However, the embodiments are not limited to the described embodiment, and a person skilled in the art will appreciate that many other embodiments are possible without deviating from the basic concept and that any such work around will also fall under the scope. It is envisioned that other styles and configurations of the present embodiments can be easily incorporated into the teachings, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

There is provided a character pillow having incorporated thermal elements as shown in FIGS. 1-9. As disclosed, the character pillow has a main body having a plurality of external features that may include a representation of common designs recognizable by children such as a rainbow, or character figure features such as an eye area, a pair of paw areas, a pair of arms, a pair of legs, a face, a pair of ears, or a tail. The above are provided by means of explanation and not intended to be limiting. A pillow member 11 has an outer shell of preferably plush material but may comprise any other material such as cotton, leather or polyester, creating an esthetically pleasing exterior. The pillow member is made up of an upper layer 13 and a lower layer 15 that are secured to one another at their edges to form a shell 17. The shell 17 has a preferably dorsal or rear opening 19 that will accommodate resilient fill material 20 to be placed in the interior of the shell 17. The resilient fill material may be polyester batting or cotton or even a non-flammable type of material that provides bulk and shape to the shell. The opening 19 is of sufficient length and width to provide insertion and removal of an energy or battery pack 23. The energy pack may also include any other source of energy that can provide a heat source.

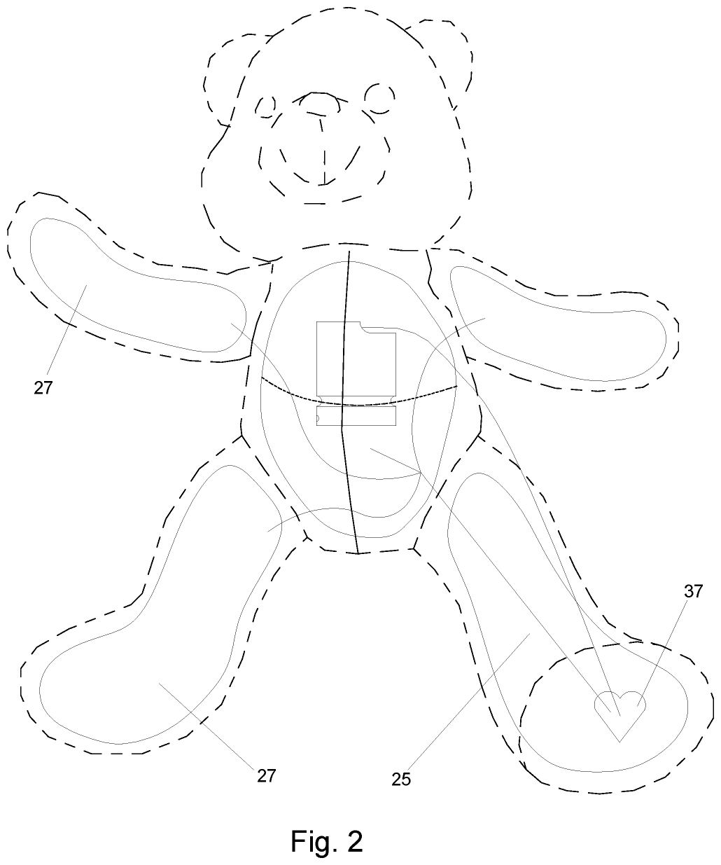

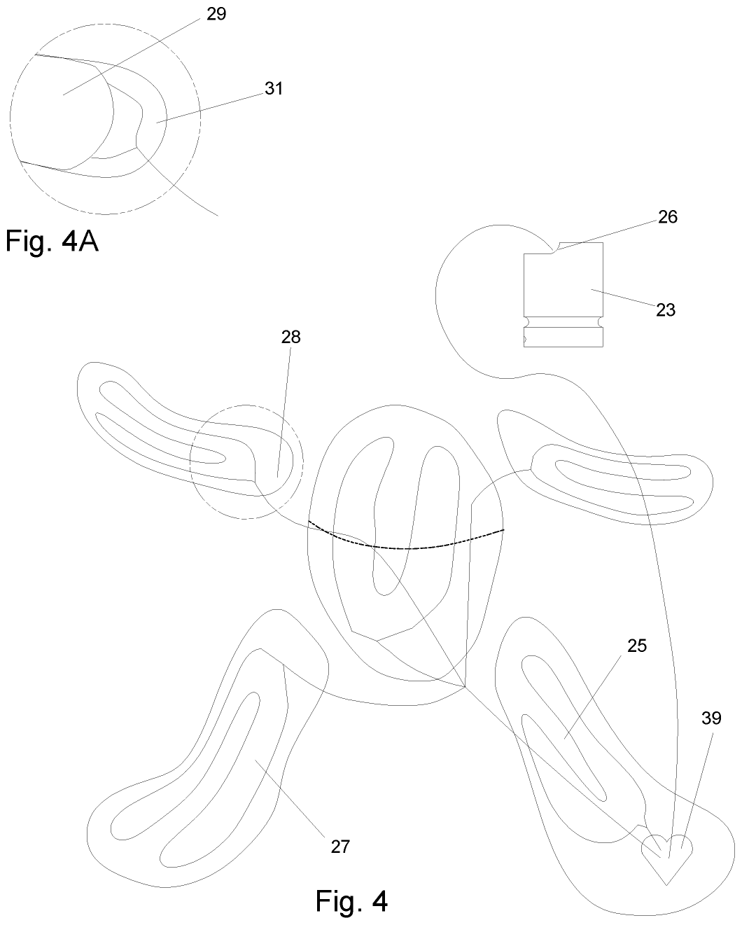

The opening includes a pocket member 21 that is accessible from the opening and is designed to enclose and support the battery pack 23. The battery pack 23 is part of a thermal or heat element 22 comprising the battery pack 23, at least one wire member 25 extending from the battery pack 23, at least one thermal pad 27 electrically connected to the wire member(s) 25. The thermal element wires 25, which are preferably carbon fiber wires that are capable of conducting heat through the thermal pads 27, extend outwardly from the battery pack with terminal ends 26 inserted within and electrically connected to the battery pack. Opposite terminal ends 28 of the wires are inserted between dual layers 29, 31 of the thermal pads 27 as shown in FIG. 4A. The wire 25 is aligned within each thermal pad 27 to provide maximum dispersion of heat as shown in FIG. 4. The dual layers 29 and 31 are made up of a non-woven conduction fabric that is joined and superimposed over the wires 25, allowing for heat transfer. In one form, the thermal pads 27 are disposed within and interspersed throughout the interior of the pillow, preferably in appendages and the main body for maximum heat displacement. The battery pack 23 may include alkaline or rechargeable batteries (not shown) that are contained within the battery pack and an external on/off switch 35 located on the battery pack housing 37. The thermal element 22 also includes a remote on/off switch 39 that includes a heat adjustment feature 41 that may also be present on the battery pack, preferably having at least two levels of heat settings. The remote on/off switch 39 is located on an exterior surface of the pillow, as shown in FIG. 2 and may be in the shape of a heart or some other figure. The remote switch 39 preferably has an exterior, silicone surface and is activated on/off by pressing the button or heart one time.

In the current form, there are three temperature settings high, medium and low for different levels of comfort. A low heat setting that shows the color yellow is activated with pressing the switch 39 for approximately five seconds, thereby activating the device; a medium setting showing the color orange with an additional press of the switch and a high setting that shows the color red on the switch or heart 39 with another press of the switch. A final press and hold of the of the switch 39 for five seconds will turn off the thermal element. These settings provide a means for controlling the temperature level of the thermal element as well as a means for disabling the thermal element. The battery pack may also include an on/off light 38 to indicate whether the unit is on or off. There is also anticipated a remote application so that the activation of the switch as well as the temperature control may be modified with a remote application located on a cellular device. The thermal element 22 also has an automatic shut-off feature that shuts the thermal element off automatically within 30 minutes of heat activation. The battery pack 23 includes a charge port 45, a charge cord 47 and an A/C plug 49.

Referring in more detail to FIG. 1, the embodiment shows a combined stuffed animal with heating pad device 51, providing for a stuffed animal body 53 that includes heating capabilities for comfort but may also include auditory and visual capabilities. The stuffed animal body is provided with various external features such as arms, legs, face, ears, and the like as would be customarily expected. The exact nature of the external features will vary per the style of the character pillow 11. The exact nature of the character pillow and external features is not intended to be a limiting factor of the present embodiment. An eye area 55 may be provided with light-emitting diodes (LEDs) 57 for increasing the aesthetic visual quality of the character pillow 11. One (1) of the two (2) paw areas 59, 61 is provided with the remote switch 39 for controlling the electrical functionality of the device 11. Further description of the electrical functionality of the device will be provided herein below.

The character pillow 11 is provided with the charging port 45 which connects to the charging cable 47. The distal end of the charging cable 47 may connect to a USB charging adapter (not shown) which in turn connects to an AC power plug 49 for purposes of charging the device 11. The center torso area, 63 is provided with the opening 19, as previously described, and preferably a fastening means 65, such as a zipper (as shown), hook-and-loop-type fastener (Velcro®), snaps, or the like. The exact method of the fastening means 65 utilized is not intended to be a limiting factor of the present embodiment. The opening 19 provides access to internal electrical components of the device 11 (as will be described below) for purposes of maintenance, repair, or removal of the battery pack 23 for purposes of washing the character pillow 11.

Referring to FIG. 2 and FIGS. 6-8, the interior of the center torso area contains the battery pack 23 and rechargeable battery for powering the device. The rechargeable battery is charged via a charging regulator (not shown) that is connected to the charging port 45. The power switch or button 39, located in the paw area is electrically connected via internal wiring 25. Similarly, the light-emitting diodes (LEDs) 57 may be connected via internal wiring as well. A speaker 81 may also be electrically connected to a wireless transmitter 82. The wireless transmitter 82, preferably using Bluetooth® protocol is paired to a user's or care provider's personal electronic device for the purposes of playing audible entertainment material such as music through the speaker 81. This feature is envisioned to provide increased comfort and enjoyment by the user of the device 11 by aiding relaxation, sleeping and the like. The series of resistance heaters or thermal pads 27 are located in the stuffing material of the stuffed animal body 53. These thermal pads 27 are energized by the rechargeable battery to produce a comfortable amount of low-level heat for the purposes of pain relief and overall comfort when held close to the user's body.

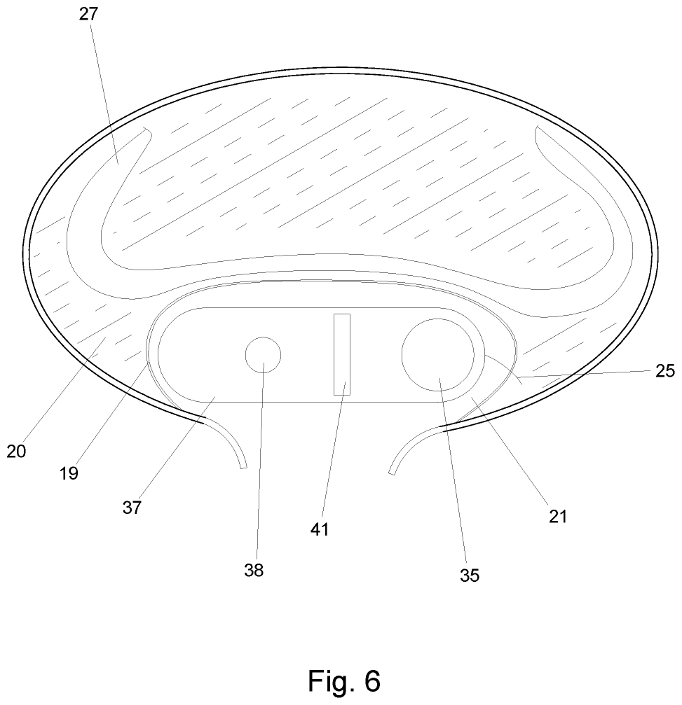

Referring now to FIG. 6, this view shows a cavity or opening 19 having an internal cloth divider forming the pocket 21 that separates the stuffing material from the battery pack 23. The pocket 21 allows for easy removability of the battery pack so that the pillow 11 may be washed and also protects a user from access to the thermal pads 27. The opening 19 then contains the battery pack with the rechargeable battery, the charging regulator (not shown), the internal wiring 25, and possibly the speaker 81 but some embodiments will not have this feature. The pillow may also contain a speaker that is preferably water tight, and electrically connected to a wireless transmitter that is adapted to be paired to a personal electronic device to play audible entertainment material through the speaker.

Referring to FIGS. 2-4A, a detail view of the thermal element shows the power switch 39 located near the outer surface of the paw area to allow the user to easily activate it. The internal wiring 25 is attached to the power switch 39 to provide electrical connectivity. The power switch 39 is held in position via the stuffing material within the paw area, while the thermal pads 27 are located remote from the battery pack and dispersed throughout the pillow so as to conduct heat more easily to the user.

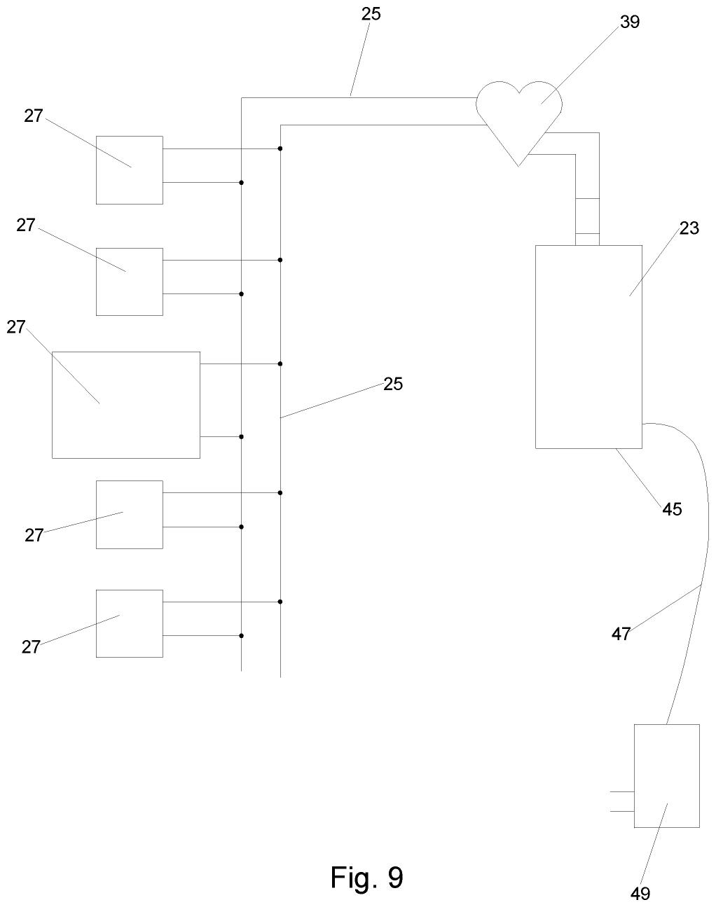

Referring to FIG. 9, an electrical block diagram of the device 11 is shown. Electrical power is derived from the charging adapter 49 and routed along the charging cable 47 to the charging port 45. The charging port 45 is then electrically connected to the charging regulator which controls the charging current to the rechargeable battery in the battery pack 23. This allows for the rechargeable battery to be charged even if the device 11 is off and not being used. In some embodiments, a motor (not shown) is also provided that, when energized, activates a vibrating device that transmits a slight vibratory effect to the device 11 to aid in soothing the user. When being utilized, the power switch 39 conducts power to the multiple thermal pads 27 through the wire 25. The thermal pads are wired in parallel and a wireless transmitter which is paired to the user's or care provider's personal electronic device to allow for playback of audio material through the speaker 81 may also be wired in parallel.

The preferred embodiment can be utilized by the common user in a simple and effortless manner with little or no training. After procurement and prior to utilization, the device 11 would be prepared in the following manner: the charging cable 47 would be connected to an AC power outlet; the charging cable 47 would be connected between the complete charging of the rechargeable battery and battery pack 23, the device 11 is then ready for use. When charging the device, it is recommended to first unplug the battery pack from the thermal element, then plug the battery pack into the wall charging port. Once charged, the battery pack is removed from the wall charger and electrically connected to the thermal element for use. During the charging period, once the battery pack is removed, the pillow 11 may be washed and exposed to water to clean the pillow.

During utilization of the device charging adapter 49 and to the charging port 45; after a suitable period of time to ensure charging, the following procedure would be initiated: the user would press the on/off switch 37 and after a period of warm up time, the thermal elements would provide warmth for the user in much the same manner as a sleeping pad. In the current form, the three temperature settings high, medium and low for different levels of comfort, may be utilized. The low heat setting that shows the color yellow is activated with pressing the switch 39 for approximately five seconds, thereby activating the device; a medium setting showing the color orange with an additional press of the switch and a high setting that shows the color red on the switch or heart 39 with another press of the switch. A final press and hold of the of the switch 39 for five seconds will turn off the thermal element. If LEDs are present, electrical operation can be verified via the illumination of the light-emitting diodes (LEDs) 57 in the eye areas 55. Should audio playback be desired, the user would pair their personal electronic device with the wireless transmitter 82 to allow for playback of soothing audio material via the speaker 81. If provided, a motor may provide a soothing vibratory effect to the device 11. After use of the device 11, it is simply deactivated via the power switch 37. The rechargeable battery 23 may then be recharged for future use in a cyclical manner.

The foregoing descriptions of specific embodiments have been presented for purposes of illustration and description. They are not intended to be exhaustive or to limit the embodiments to the precise forms disclosed, and obviously many modifications and variations are possible in light of the above teaching. The embodiments were chosen and described in order to best explain the principles of the device and its practical application, to thereby enable others skilled in the art to best utilize the device and various embodiments with various modifications as are suited to the particular use contemplated.

What is claimed is:

1. A character pillow incorporating a heating element, comprising;
an outer shell having a decorative surface;
said outer shell encasing a resilient fill material and having an interior pocket member with a closure;
at least one thermal element disposed within said fill material;
said at least one thermal element including a removable energy pack;
said thermal element including dual layer pads encasing a terminal end of at least one wire member;
said at least one wire member electrically connected to said energy pack;
said interior pocket member adapted to hold said energy pack;
said at least one thermal element connected to a rechargeable energy source contained within said energy pack; and
said character pillow adapted to be immersible in water.

2. The character pillow according to claim 1 wherein said energy pack has an external energy source.

3. The character pillow according to claim 1 wherein said interior pocket permits access to said energy pack.

4. The character pillow according to claim 1 wherein said at least one thermal element extends outwardly within an interior of said pillow.

5. The character pillow according to claim 1 wherein said interior pocket is aligned with a seam member.

6. The character pillow according to claim 1 wherein said interior pocket has a seam along an exterior opening in said shell.

7. The character pillow according to claim 1 wherein said energy pack has an automatic timer.

8. The character pillow according to claim 1 wherein said pillow has an activation button on an exterior surface of said pillow.

9. The character pillow according to claim 8 wherein activation button has at least two temperature control settings.

10. A character pillow, the improvement comprising:
an exterior shell having an upper layer and a lower layer;
a non-flammable fill material encased within said exterior shell layers;
a pocket member having terminal edges secured to an opening in said lower layer;
a heating element encased within said fill material;
said heating element including a removable battery pack with rechargeable batteries and an external energy source;
said battery pack positioned within said pocket member;
said heating element having wire members with at least one terminal end interposed between dual layers of thermal pads;
said pillow having an activation button on an exterior surface of said upper or lower layer;
means for automatically disabling said heating element after a selectively variable duration; and
means for automatically controlling an operating temperature range of said heating element.

11. The character pillow according to claim 10, wherein said pocket member has an internal cloth divider that houses said battery pack.

12. The character pillow according to claim 10 wherein said temperature control means is positioned on an exterior layer of said pillow.

13. A stuffed animal, comprising:
a body having a plurality of external features that include an eye area, a pair of paw areas, a pair of arms, a pair of legs, a face, a pair of ears, an outer surface, and a plurality of stuffing material;
a charging port connecting to a charging cable, a distal end of the charging cable connects to an AC power outlet to charge the stuffed animal, the charging port is disposed on the body;
a center torso area having a cover that is held by a fastening means, the fastening means joins said cover to the outer surface of the body, the center torso area is disposed on the body; and
a series of resistance heaters disposed in the stuffing material of the stuffed animal body near the outer surface of the body; and wherein the charging port is electrically connected to a charging regulator which controls a plurality of charging current to a rechargeable battery to allow for the rechargeable battery to be charged even if the stuffed animal is off and not being used.

14. The stuffed animal, according to claim 13, wherein one of the pair of paw areas includes a power switch and wherein said power switch is electrically connected by a plurality of internal wiring.

15. The stuffed animal, according to claim 13, wherein the cover covers and accesses a plurality of internal electrical components for maintenance, repair, removal, or washing the body.

16. The stuffed animal, according to claim 13, wherein the fastening means is a fastener selected from the group consisting of a zipper, a hook-and-loop-type fastener, or one or more snaps.

17. The stuffed animal, according to claim 13, further comprising a cavity under the removable cover at the center torso area having an internal cloth divider that retains the stuffing material about the center torso area.

18. The stuffed animal according to claim 13 wherein said heating element includes means for automatically disabling said heating element after a selectively variable duration;

19. The stuffed animal, according to claim 13, wherein the wireless transmitter is adapted to be paired to the personal electronic device for playback of audio material through the speaker and is wired in parallel.

20. The stuffed animal, according to claim 13, further comprising a motor that activates a vibrating device that transmits a slight vibratory effect to the stuffed animal to aid in adapted to be soothing a user.
